(19) United States
(12) Patent Application Publication
(10) Pub. No.: US 2026/0303934 A1
(43) Pub. Date: Oct. 1, 2026

(54) CAMERA MODULE

(71) Applicant: Samsung Electro-Mechanics Co., Ltd., Suwon-si (KR)

(72) Inventors: Bo Sung SEO, Suwon-si (KR); Nam Ki PARK, Suwon-si (KR); Young Bok YOON, Suwon-si (KR); Jae Sung OH, Suwon-si (KR); Byung Woo KANG, Suwon-si (KR)

(73) Assignee: Samsung Electro-Mechanics Co., Ltd., Suwon-si (KR)

(21) Appl. No.: 19/629,010

(22) Filed: Mar. 26, 2026

(30) Foreign Application Priority Data
Mar. 31, 2025 (KR) 10-2025-0041091
Feb. 13, 2026 (KR) 10-2026-0029414

(51) Int. Cl. H04N 23/51; H04N 23/55; H04N 23/57

(52) U.S. Cl. CPC H04N 23/51; H04N 23/55; H04N 23/57

(57) ABSTRACT

A camera module includes a base; a first carrier supported by the base and configured to move in a direction perpendicular to an optical axis direction; a second carrier supported by the first carrier and configured to move in the optical axis direction; and an optical member disposed in the second carrier, wherein a first support member that supports a movement of the second carrier in the optical axis direction is disposed between the first carrier and the second carrier, the first support member is disposed between a first corner portion that is disposed at an edge at which two adjacent side surfaces of the second carrier meet and a second corner portion disposed at an edge at which two adjacent side surfaces of the first carrier meet, and wherein the second corner portion faces the first corner portion in the direction perpendicular to the optical axis direction.

### CROSS-REFERENCE TO RELATED APPLICATIONS

This application claims the benefit under 35 USC §119(a) of Korean Patent Application No. 10-2025-0041091 filed on Mar. 31, 2025, and Korean Patent Application No. 10-2026-0029414 filed on Feb. 13, 2026, in the Korean Intellectual Property Office, the entire disclosures of which are incorporated herein by reference for all purposes.

### BACKGROUND

### 1. Field

The following description relates to a camera module.

### 2. Description of Related Art

A camera module may be typically installed in a portable electronic apparatus including, but not limited to, a smartphone, a tablet personal computer (tablet PC), a laptop, or the like.

Portable electronic apparatuses may be included in a product group that is sensitive to an overall size including a thickness, and in particular, in the example of a smartphone, sensitivity is higher.

Accordingly, the camera module that is implemented in the portable electronic apparatus may also need to be manufactured to have a suitable size.

Recently, as the camera module that is implemented in the portable electronic apparatus achieves higher degrees of performance, a structure of the camera module becomes gradually more complex.

That is, technical difficulty may exist in miniaturizing a size of the camera module while maintaining or improving performance of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a base; a first carrier supported by the base, and configured to move in a direction perpendicular to an optical axis direction; a second carrier supported by the first carrier, and configured to move in the optical axis direction; and an optical member disposed in the second carrier, wherein a first support member that supports a movement of the second carrier in the optical axis direction is disposed between the first carrier and the second carrier, wherein the first support member is disposed between a first corner portion that is disposed at an edge at which two adjacent side surfaces of the second carrier meet and a second corner portion that is disposed at an edge at which two adjacent side surfaces of the first carrier meet, and wherein the second corner portion faces the first corner portion in the direction perpendicular to the optical axis direction.

The first support member may be a first ball member, and the first ball member may include two balls that are disposed in the optical axis direction.

A first guide groove portion that is defined by the two adjacent side surfaces of the second carrier may be disposed at the first corner portion, a second guide groove portion that is defined by the two adjacent side surfaces of the first carrier, and facing the first guide groove portion may be disposed at the second corner portion, and the first support member may be disposed between the first guide groove portion and the second guide groove portion.

A first magnet and a second magnet may be disposed in the second carrier at positions that are spaced apart from the first support member in the direction perpendicular to the optical axis direction, and a first coil that faces one of the first magnet and the second magnet, a first yoke that faces the first magnet, and a second yoke that faces the second magnet, may be disposed in the first carrier.

The second carrier may include a first side surface and a second side surface that are perpendicular to each other, wherein the first magnet may be disposed on the first side surface, and wherein the second magnet may be disposed on the second side surface.

The first yoke may face the first magnet in a first axis direction perpendicular to the optical axis direction, and wherein the second yoke may face the second magnet in a second axis direction perpendicular to both the optical axis direction and the first axis direction.

The first yoke and the second yoke may each include of a magnetic material, and the first magnet and the first yoke and the second magnet and the second yoke are configured to generate magnetic attractive forces in directions in which the first magnet and the first yoke face each other, and in which the second magnet and the second yoke face each other.

The first magnet may be spaced apart from the first support member by a first distance D1 in the second axis direction, and the second magnet may be spaced apart from the first support member by a second distance D2 that is different from the first distance D1 in the first axis direction.

The first coil may be configured to face the first magnet, and the first distance D1 may be less than the second distance D2.

The first carrier or the second carrier may include an auxiliary support portion that is disposed to be spaced apart from the first support member in the first axis direction.

A second support member that supports a movement of the first carrier in the direction perpendicular to the optical axis direction may be disposed between the base and the first carrier, and the first carrier may be configured to move in a first axis direction perpendicular to the optical axis direction and in a second axis direction perpendicular to both the optical axis direction and the first axis direction.

The second support member may be a second ball member, the second ball member may include three balls, and the second ball member may be disposed at a position that is spaced apart from the first support member in the direction perpendicular to the optical axis direction.

When viewed in the optical axis direction, the base may have a quadrangular shape having four corner regions, and one of the first support member and the second support member may be disposed in each of the four corner regions.

A third magnet and a fourth magnet may be disposed perpendicularly to each other in the first carrier or the base, and a second coil and a third coil may be disposed in the base or the first carrier to face the third magnet and the fourth magnet in the optical axis direction.

The fourth magnet may include a plurality of magnets, the second coil may include a number of coils that correspond to a number of the third magnets, and the third coil may include a number of coils that correspond to a number of the fourth magnets.

The camera module may further include a plurality of position sensors that are disposed to face the third magnet and the fourth magnet, respectively, wherein a number of the position sensors that face the fourth magnets may correspond to a number of the fourth magnets.

The camera module may further include a shield can that is coupled to the base, and a connection substrate that is disposed between the first carrier and the shield can.

The connection substrate may include a movable portion in which the first coil and the first yoke are disposed, and which is configured to move together with the first carrier, and a fixed portion that is coupled to the shield can.

The optical member may include a plurality of lenses that are disposed in the optical axis direction.

In a general aspect, a camera module includes a lens module configured to move in an optical axis direction; a carrier in which the lens module is disposed, and which is supported by a base; a first magnet and a second magnet which are disposed perpendicularly to each other in the lens module; a first coil disposed in the carrier; a first yoke and a second yoke disposed perpendicularly to each other; and a first support member disposed between the lens module and the carrier and configured to support a movement of the lens module in the optical axis direction, wherein the first magnet faces the first coil and the first yoke, wherein the second magnet faces the second yoke, and wherein the first support member is disposed between the first yoke and the second yoke.

The first magnet and the first yoke may face each other in a first direction perpendicular to the optical axis direction, the second magnet and the second yoke may face each other in a second direction perpendicular to both the optical axis direction and the first direction, and the first yoke and the second yoke may each include a magnetic material, and are each configured to generate magnetic attractive forces toward the first magnet and the second magnet.

The first magnet may be spaced apart from the first support member by a first distance D1 in the second direction, the second magnet is spaced apart from the first support member by a second distance D2 in the first direction, and the first distance D1 may be less than the second distance D2.

The lens module may include a lens barrel in which a plurality of lenses are disposed in the optical axis direction and a lens holder coupled to the lens barrel, and the first support member may be disposed to be in contact with the lens holder and the carrier.

The lens holder may include an extension portion that protrudes toward the base in the optical axis direction at a position where the first support member is disposed, and the base may include a receiving groove that faces the extension portion in the optical axis direction and the extension portion is disposed in the receiving groove.

The first support member may be a first ball member comprising a plurality of balls, and the receiving groove may include a step portion that protrudes toward the first ball member in the optical axis direction.

The camera module may further include a shield can coupled to the base, wherein the first support member is a first ball member comprising a plurality of balls, and wherein the shield can comprises a protrusion portion that protrudes toward the first ball member in the optical axis direction.

A substrate may be disposed in the carrier, and the first coil may be disposed on one surface of the substrate facing the lens module.

The first yoke may be disposed in the carrier through the substrate, and the second yoke may be directly disposed in the carrier.

The camera module may further include a third magnet and a fourth magnet disposed in the carrier or the base; a second coil and a third coil disposed in the base or the carrier to face the third magnet and the fourth magnet in the optical axis direction; and a second ball member disposed between the carrier and the base, wherein the carrier may be configured to move relative to the base in a direction perpendicular to the optical axis direction.

The third magnet and the fourth magnet may be disposed perpendicularly to each other, and one of the third magnet and the fourth magnet may include one magnet, and another of the third magnet and the fourth magnet may include two magnets.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a plan view of the example camera module without a shield can, in accordance with one or more embodiments.

FIG. 3 illustrates a perspective view of the example camera module without a shield can, in accordance with one or more embodiments.

FIG. 4 illustrates an exploded perspective view of the example camera module, in accordance with one or more embodiments.

FIG. 5 illustrates an exploded perspective view of an example optical module, in accordance with one or more embodiments.

FIG. 6 illustrates a plan view of the example optical module, in accordance with one or more embodiments.

FIG. 7 illustrates an exploded perspective view of a focus adjustment unit, in accordance with one or more embodiments.

FIG. 8 illustrates a plan view of the focus adjustment unit, in accordance with one or more embodiments.

FIG. 9 illustrates a cross-sectional view taken along line I–I’ of FIG. 1.

FIG. 10 illustrates a view of a rotational moment occurring in the example optical module, in accordance with one or more embodiments.

FIG. 11 illustrates an exploded perspective view of an example image stabilization unit, in accordance with one or more embodiments.

FIG. 12 illustrates an exploded bottom perspective view of the example image stabilization unit, in accordance with one or more embodiments.

FIG. 13 illustrates a perspective view of a connection substrate, in accordance with one or more embodiments.

FIG. 14 illustrates a first side view of a connection substrate (in a coupled state), in accordance with one or more embodiments.

FIG. 15 illustrates a second side view of the connection substrate (in the coupled state), in accordance with one or more embodiments.

FIG. 16 illustrates a plan view of the connection substrate (in the coupled state), in accordance with one or more embodiments.

FIG. 17 illustrates a plan view of positions of a first support member and a second support member, in accordance with one or more embodiments.

FIG. 18 illustrates a perspective view of the positions of the first support member and the second support member, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module having a slim thickness.

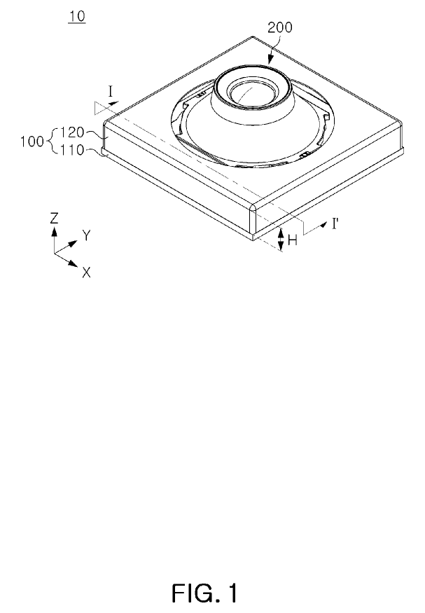

FIG. 1 illustrates a perspective view of an example camera module, in accordance with one or more embodiments.

A camera module 10, in accordance with one or more embodiments, may be implemented in portable electronic apparatus such as, but not limited to, a smartphone, a tablet personal computer (tablet PC), or a laptop, as only examples.

In an example embodiment, the camera module 10 may be implemented in a smartphone, and in this example, a thickness direction (Z-axis direction) of the camera module 10 may correspond to a thickness direction of the smartphone.

According to an example embodiment, the camera module 10 may have a very slim thickness in the thickness direction (Z-axis direction).

A thickness H of the camera module 10 may correspond to a height of a fixed body 100 of the camera module 10. Referring to FIG. 1, the fixed body 100 may include a base 110 and a shield can 120 coupled to the base 110, and the height of the fixed body 100 may be a distance from a bottom surface of the base 110 to a top surface of the shield can 120.

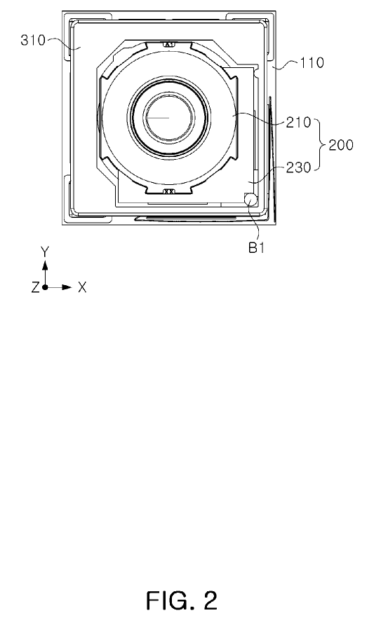

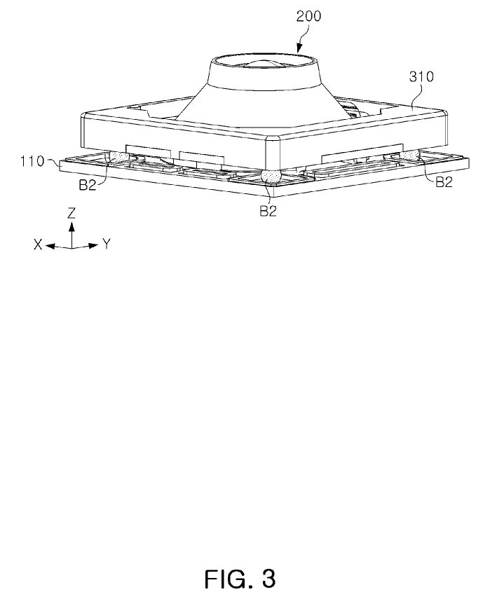

FIG. 2 illustrates a plan view of the example camera module without a shield can, in accordance with one or more embodiments, and FIG. 3 is a perspective view of the example camera module without a shield can, in accordance with one or more embodiments.

According to an example embodiment, the camera module 10 may include an optical module 200. The optical module 200 may include an optical member, and the optical member may have an optical axis parallel to the thickness direction (Z-axis direction) of the camera module 10.

The camera module 10, in accordance with one or more embodiments, may have an auto focusing (AF) operation and an optical image stabilization (OIS) operation. The auto focusing operation may be implemented by moving the optical module 200 in an optical axis direction (Z-axis direction), and the optical image stabilization operation may be implemented by moving the optical module 200 in directions (X-axis direction and Y-axis direction) perpendicular to an optical axis (Z-axis).

Referring to FIGS. 2 and 3, the camera module 10 may include a first support member and a second support member that guide a movement of the optical module 200.

According to an example embodiment, the first support member may be a first ball member B1, and the second support member may be a second ball member B2.

The first ball member B1 may guide movement of the optical module 200 in the optical axis direction (Z-axis direction). In an example, the first ball member B1 may include two ball members that are disposed in the optical axis direction (Z-axis direction), and as illustrated in FIG. 2, the first ball member B1 may be disposed in one corner region of the camera module 10.

The second ball member B2 may guide a movement of the optical module 200 in the directions (X-axis direction and Y-axis direction) perpendicular to the optical axis (Z-axis). Referring to FIG. 3, the second ball member B2 may include three ball members, and, in an example, the three ball members may be disposed adjacent to different corner regions of the camera module 10, respectively.

In the above description, a corner region is not limited to a point geometrically defined as a corner, and may indicate a predetermined range of a region including an adjacent portion (or a surrounding portion) around a corner.

According to an example embodiment, when viewed in the optical axis direction (Z-axis direction), the camera module 10 may have a quadrangular shape having four corner regions, and the first ball member B1 or the second ball member B2 may be disposed in the four corner regions.

According to an example embodiment, the first ball member B1 and the second ball member B2 which guide a movement of the optical module 200 may be disposed not to overlap each other in the optical axis direction (Z-axis direction), thereby preventing the thickness H of the camera module 10 from unnecessarily increasing due to overlap of the ball members.

Hereinafter, a structure of the camera module 10, in accordance with one or more embodiments, is described in more detail.

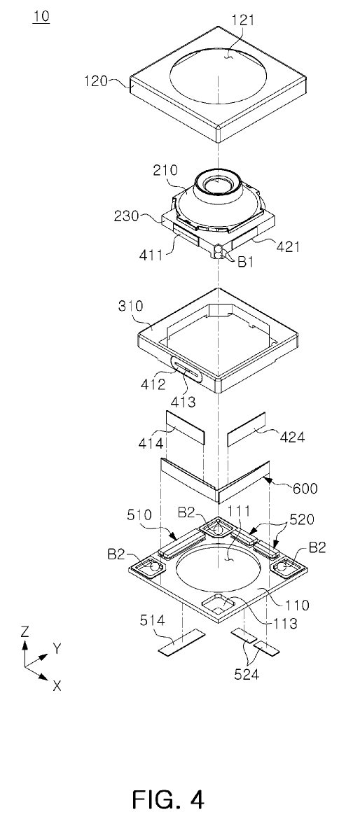

FIG. 4 illustrates an exploded perspective view of the example camera module, in accordance with one or more embodiments.

The camera module 10 according to an example embodiment may include, as the fixed body 100, the base 110 and the shield can 120, and may include a movable body accommodated in the fixed body and configured to move relative to the fixed body 100. The movable body may include the optical module 200 that moves relative to the fixed body 100 in the optical axis direction (Z-axis direction) and a carrier 310 that moves relative to the fixed body 100 together with the optical module 200 in directions (X-axis direction and Y-axis direction) perpendicular to the optical axis (Z-axis).

According to an example embodiment, the movable body may include a first carrier 310 supported by the base 110 and movable in the directions (X-axis direction and Y-axis direction) perpendicular to the optical axis (Z-axis), and a second carrier supported by the first carrier 310 and movable in the optical axis direction (Z-axis direction). The second carrier may be a part of the optical module 200, and the optical member may be disposed in the second carrier.

In the following description, the carrier 310 corresponds to the first carrier, and a lens holder 230 corresponds to the second carrier.

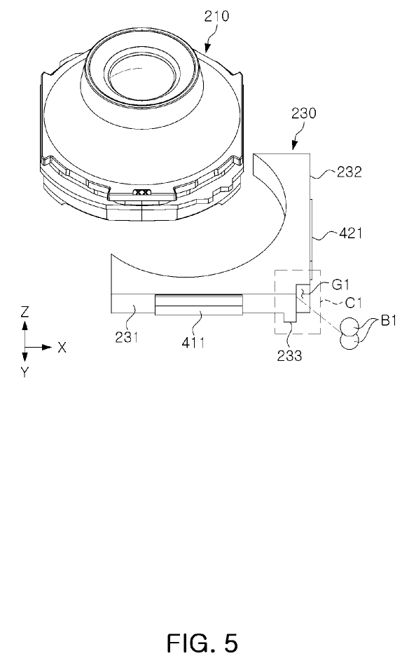

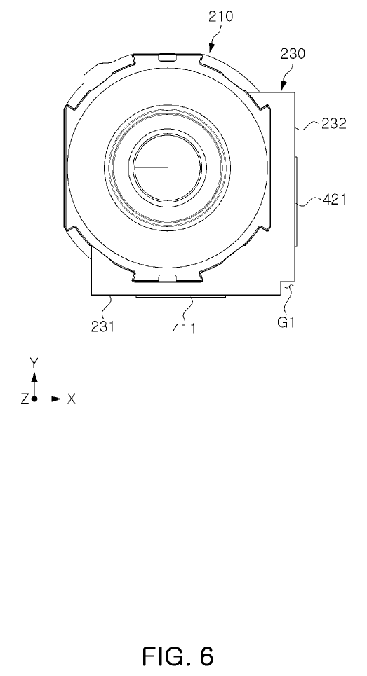

FIG. 5 illustrates an exploded perspective view of the optical module according to an example embodiment, and FIG. 6 illustrates a plan view of the optical module according to an example embodiment.

Referring to FIGS. 4 through 6, the optical module 200 according to an example embodiment may be a lens module. However, according to an example embodiment, the optical module 200 is not limited to the lens module, and in other example embodiments, a reflection module or an image sensor module may be the optical module.

The lens module 200 may include a lens barrel 210 and the lens holder 230 coupled to the lens barrel 210.

The lens barrel 210 may include a plurality of lenses mounted therein in the optical axis direction (Z-axis direction). In an example embodiment, the above-described optical member may include the plurality of lenses.

A portion of the lens barrel 210 may be disposed outside the shield can 120. In an example embodiment, the shield can 120 may include a first opening 121 that is open in the optical axis direction (Z-axis direction), and a portion of the lens barrel 210 may be disposed by passing through the first opening 121. Accordingly, external light may be incident on lenses mounted in the lens barrel 210.

The lens holder 230 may include a first side surface 231 and a second side surface 232 disposed adjacent to each other.

The lens holder 230 may further include a first corner portion C1 at a portion where the first side surface 231 and the second side surface 232 meet, and a first guide groove portion G1, in which the first ball member B1 described above is disposed, may be disposed at the first corner portion C1.

The lens holder 230 may have a length at the first corner portion C1 that extends in the optical axis direction (Z-axis direction). That is, the first corner portion C1 of the lens holder 230 may have a greater length in the optical axis direction (Z-axis direction) than other portions of the lens holder 230. Hereinafter, the corresponding portion is defined as an extension portion 233.

The base 110 may include a receiving groove 113 which has a lower height in the optical axis direction (Z-axis direction) than other portions at a position corresponding to the extension portion 233. The extension portion 233 may be disposed in the receiving groove 113 to be spaced apart from a bottom surface of the receiving groove 113 in the optical axis direction (Z-axis direction).

The extension portion 233 may form a part of the first guide groove portion G1. Accordingly, the first guide groove portion G1 may have a sufficient length in the optical axis direction (Z-axis direction), and the two ball members included in the first ball member B1 may be stacked and disposed in the first guide groove portion G1 in the optical axis direction (Z-axis direction).

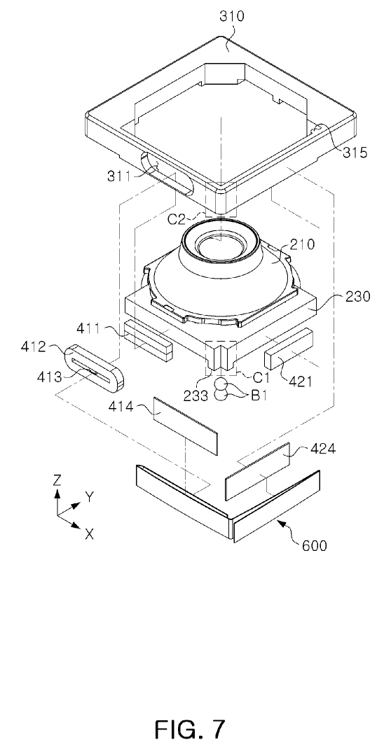

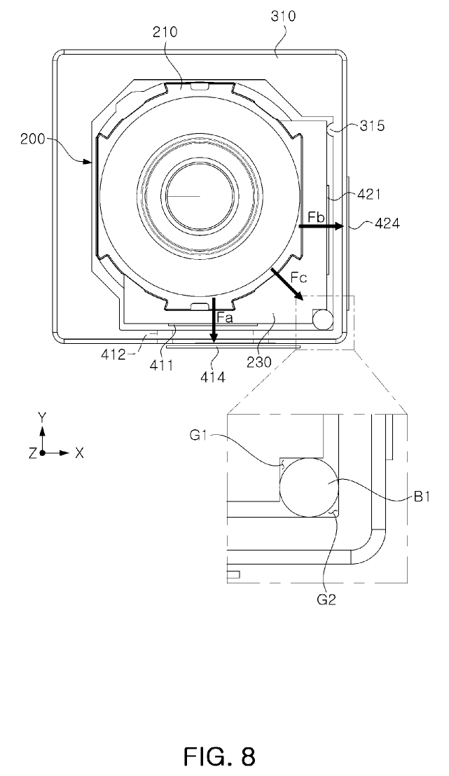

FIG. 7 illustrates an exploded perspective view of a focus adjustment unit, in accordance with one or more embodiments, and FIG. 8 illustrates a plan view of the focus adjustment unit, in accordance with one or more embodiments.

The camera module 10 may include the carrier 310 which accommodates the lens module 200. The carrier 310 may be open in the optical axis direction (Z-axis direction), and the lens module 200 may be accommodated in an open portion of the carrier 310.

In an example in which the lens module 200 is accommodated in the carrier 310, the first side surface 231 and the second side surface 232 of the lens holder 230 may face two side surfaces of the carrier 310 perpendicular to each other, respectively.

The carrier 310 may include a second corner portion C2 that is formed or disposed at a portion where two side surfaces of the carrier 310, facing the first side surface 231 and the second side surface 232 of the lens holder 230, meet. The second corner portion C2 may face the first corner portion C1 in a diagonal direction, and the first ball member B1 may be disposed between the first corner portion C1 and the second corner portion C2. The diagonal direction may be one direction among directions perpendicular to the optical axis (Z-axis).

More specifically, a portion of the second corner portion C2 facing the first guide groove portion G1 in the diagonal direction may be defined as a second guide groove portion G2 (that is, the second corner portion C2 indicates a wider region than the second guide groove portion G2), and the first ball member B1 may be disposed between the first guide groove portion G1 and the second guide groove portion G2.

The lens module 200 may move relative to the carrier 310 in the optical axis direction (Z-axis direction) by the first ball member B1.

The first ball member B1 may roll in the optical axis direction (Z-axis direction) based on a driving force that is generated by a focus driving unit described below (hereinafter, referred to as a first driving unit) in a state of being in contact with the first guide groove portion G1 and the second guide groove portion G2.

The first guide groove portion G1 and the second guide groove portion G2 may include two side surfaces with which the first ball member B1 is in contact, respectively. That is, the first ball member B1 may be in two-point contact with each of the first guide groove portion G1 and the second guide groove portion G2 (four-point contact in total). The first ball member B1 may roll in the optical axis direction (Z-axis direction) in a state of being in contact with two side surfaces of each of the first guide groove portion G1 and the second guide groove portion G2.

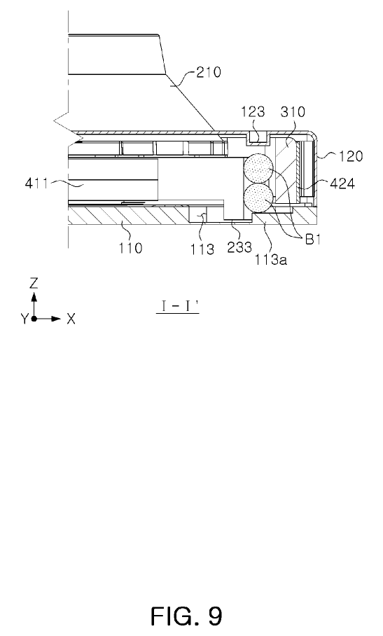

FIG. 9 illustrates a cross-sectional view taken along line I–I’ of FIG. 1.

The base 110 and the shield can 120 may limit a movement distance of the first ball member B1, and may operate as a stopper preventing separation.

Referring to FIG. 9, the receiving groove 113 of the base 110 may include a step portion 113a. The step portion 113a may be a portion that protrudes from the bottom surface of the receiving groove 113 in the optical axis direction (Z-axis direction). The step portion 113a may face the first ball member B1 in the optical axis direction (Z-axis direction), and may be in contact with, or be spaced apart from, a ball member that is disposed closer to the base 110 among the ball members of the first ball member B1 depending on a position of the lens module 200.

A protrusion portion 123 may be formed on a surface of the shield can 120 facing an inner space of the camera module 10 (hereinafter, a bottom surface). The protrusion portion 123 may be a portion that protrudes from the bottom surface of the shield can 120 in the optical axis direction (Z-axis direction). The protrusion portion 123 may face the first ball member B1 in the optical axis direction (Z-axis direction), and may be in contact with, or be spaced apart from, a ball member that is disposed closer to the shield can 120 among the ball members of the first ball member B1 depending on a position of the lens module 200.

The first ball member B1 described above may be modified and implemented in a shaft form extending in the optical axis direction (Z-axis direction).

Referring to FIG. 4, a first driving unit may include a first driving magnet (or a first magnet) 411 and a first driving coil (or a first coil) 412 that are disposed to face each other.

Referring to FIGS. 6 and 8, in an example, the first driving magnet 411 may be disposed on the first side surface 231 of the lens holder 230, and the first driving coil 412 may be disposed on one side surface of the carrier 310 to face the first driving magnet 411. The first driving magnet 411 and the first driving coil 412 may face each other in the direction perpendicular to the optical axis (Z-axis).

The first driving coil 412 may be mounted on a substrate (or a connection substrate) 600, and may be disposed on one side surface of the carrier 310. One side surface of the carrier 310 may include a through-hole 311, and the first driving coil 412 may directly face the first driving magnet 411 through the through-hole 311.

The first driving magnet 411 may be magnetized to allow one surface that faces the first driving coil 412 to have both a north pole (N pole) and a south pole (S pole). In an example, the N pole (or the S pole), a neutral region, and the S pole (or the N pole) may be disposed on one surface of the first driving magnet 411 that faces the first driving coil 412 in the optical axis direction (Z-axis direction).

When power is applied to the first driving coil 412, the lens module 200 may be moved in the optical axis direction (Z-axis direction) based on an electromagnetic force that is generated between the first driving magnet 411 and the first driving coil 412.

The camera module 10 may further include a position sensor (hereinafter, a first position sensor) 413 that senses a position of the lens module 200 in the optical axis direction (Z-axis direction).

In an example, the first position sensor 413 may be a Hall sensor, and may directly face the first driving magnet 411 through the through-hole 311 in a state of being mounted on the connection substrate 600 together with the first driving coil 412. The first position sensor 413 may sense a change in magnetic flux generated by the first driving magnet 411 to sense a position of the lens module 200.

According to an example embodiment, a sub magnet (or a second magnet) 421 may be further disposed in the lens holder 230. Referring to FIGS. 6 and 8, the sub magnet 421 may be disposed on the second side surface 232 of the lens holder 230, and may be disposed perpendicular to the first driving magnet 411.

A yoke, or respective yokes, may be disposed in the carrier 310 to face the first driving magnet 411 and the sub magnet 421. In an example embodiment, the carrier 310 may include a first yoke 414 disposed to face the first driving magnet 411 and a second yoke 424 disposed to face the sub magnet 421.

In an example embodiment, the first yoke 414 may be disposed in the carrier 310 in a state of being disposed on the connection substrate 600, and the second yoke 424 may be directly disposed in the carrier 310. In an example, both the first yoke 414 and the second yoke 424 may be disposed in the carrier 310, and accordingly, even when the carrier 310 moves in the directions (X-axis direction and Y-axis direction) perpendicular to the optical axis (Z-axis), a predetermined distance between the first driving magnet 411 and the first yoke 414 and a predetermined distance between the sub magnet 421 and the second yoke 424 may be maintained. Alternatively, in an example, the second yoke 424 may be disposed on the connection substrate 600

Each of the first yoke 414 and the second yoke 424 may each be formed of a material including a magnetic material. Accordingly, attractive forces may act between the first driving magnet 411 and the first yoke 414 in a direction in which the first driving magnet 411 and the first yoke 414 face each other, and between the sub magnet 421 and the second yoke 424 in a direction in which the second magnet 421 and the second yoke 424 face each other.

The first driving magnet 411 and the first yoke 414 and the sub magnet 421 and the second yoke 424 may face each other in the direction perpendicular to the optical axis (Z-axis). Hereinafter, a direction in which the sub magnet 421 and the second yoke 424 face each other is defined as a first axis direction (X-axis direction), and a direction in which the first driving magnet 411 and the first yoke 414 face each other is defined as a second axis direction (Y-axis direction).

In an example embodiment, the first driving magnet 411 and the first yoke 414 may face each other in the second axis direction (Y-axis direction) perpendicular to the optical axis (Z-axis), and may generate an attractive force in the second axis direction (Y-axis direction). Additionally, the sub magnet 421 and the second yoke 424 face each other in the first axis direction (X-axis direction) perpendicular to the optical axis (Z-axis), and may generate a magnetic attractive force in the first axis direction (X-axis direction).

The direction in which the first driving magnet 411 and the first yoke 414 face each other, and the direction in which the sub magnet 421 and the second yoke 424 face each other may be perpendicular to each other. Accordingly, a direction of attractive force (hereinafter, first attractive force) Fa acting between the first driving magnet 411 and the first yoke 414 and a direction of an attractive force (hereinafter, second attractive force) Fb acting between the sub magnet 421 and the second yoke 424 may be perpendicular to each other.

A resultant force Fc of the first attractive force Fa acting between the first driving magnet 411 and the first yoke 414 and the second attractive force Fb acting between the sub magnet 421 and the second yoke 424 may act in the diagonal direction illustrated in FIG. 8, and a direction of the resultant force Fc may correspond to a direction toward the first ball member B1. Accordingly, the first ball member B1 may be stably supported by the first guide groove portion G1 and the second guide groove portion G2.

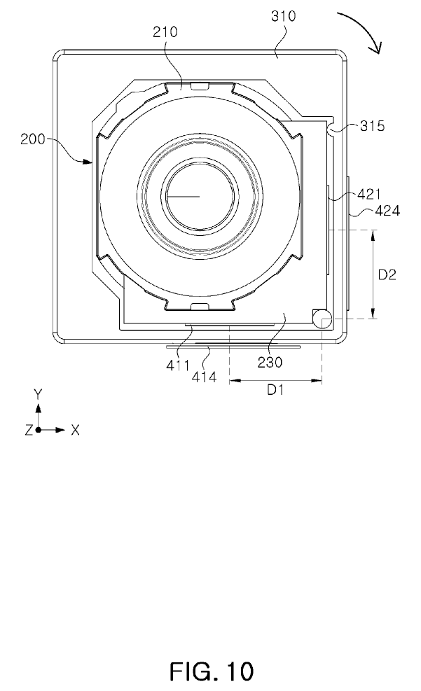

FIG. 10 is a view illustrating a rotational moment occurring in the optical module, in accordance with one or more embodiments.

According to an example embodiment, the first driving magnet 411 and the sub magnet 421 may be disposed to have different distances from the first ball member B1, and accordingly, a non-uniform rotational moment may act on the first ball member B1.

Referring to FIG. 10, a distance (hereinafter, a first distance) D1 between the center of the first driving magnet 411 and the center of the first ball member B1 may be less than a distance (hereinafter, a second distance) D2 between the center of the sub magnet 421 and the center of the first ball member B1. Such an arrangement is based on a premise that the first driving magnet 411 and the sub magnet 421 have identical sizes, and the first yoke 414 and the second yoke 424 have identical sizes.

The first attractive force Fa and the second attractive force Fb described above may act at positions that are spaced apart from the first ball member B1, and the rotational moment may thus act on the first ball member B1 based on the first attractive force Fa and the second attractive force Fb. In this example, assuming that magnitudes of the first attractive force Fa and the second attractive force Fb are substantially identical, when the second distance D2 is greater than the first distance D1, a rotational moment occurring due to the second attractive force Fb may act on the first ball member B1 more greatly than a rotational moment occurring due to the first attractive force Fa. Accordingly, the lens module 200 may be rotated clockwise as illustrated in FIG. 10.

As the lens module 200 is rotated clockwise, a distance between the second side surface 232 of the lens holder 230 and one side surface of the carrier 310 facing the second side surface 232 may decrease.

To prevent this phenomenon, according to an example embodiment, one side surface of the carrier 310 facing the second side surface 232 of the lens holder 230 may further include an auxiliary support portion 315.

The auxiliary support portion 315 may protrude from one side surface of the carrier 310 toward the second side surface 232 of the lens holder 230, and one end of the auxiliary support portion 315 may be in contact with the second side surface 232 of the lens holder 230.

In an example embodiment, the auxiliary support portion 315 may have a length in the optical axis direction (Z-axis direction), and a cross-section thereof cut in the direction perpendicular to the optical axis (Z-axis) may be provided as a shaft having a hemispherical shape. In this example, an arc portion of the auxiliary support portion 315 may be in contact with the second side surface 232. Alternatively, in another example embodiment, the auxiliary support portion 315 may be provided as a plurality of hemispherical protrusions arranged in the optical axis direction (Z-axis direction).

The auxiliary support portion 315 may be integrally formed with the carrier 310, or may be manufactured separately from the carrier 310 and then coupled to the carrier 310.

The auxiliary support portion 315 may be provided in contact with the second side surface 232 of the lens holder 230, thereby limiting rotation of the lens holder 230 even when a non-uniform rotational moment acts on the first ball member B1, and may also maintain a distance between the lens holder 230 and the carrier 310.

Additionally, the auxiliary support portion 315 may support a movement of the lens module 200 in the optical axis direction (Z-axis direction) together with the first ball member B1 by maintaining a state of being in contact with the lens holder 230.

In another example embodiment, the auxiliary support portion 315 may be formed in the lens holder 230 instead of the carrier 310. Even when the auxiliary support portion 315 is formed in the lens holder 230, the above description may be applied thereto as it is.

In other example embodiments, a non-uniform rotational moment may also be induced by disposing the first driving magnet 411 and the sub magnet 421 to have the same distance from the first ball member B1 and making a size of the first driving magnet 411 and a size of the sub magnet 421 and/or a size of the first yoke 414 and a size of the second yoke 424 different from each other. Additionally, a position of the auxiliary support portion 315 may also be changed according to a rotation direction of the lens module 200.

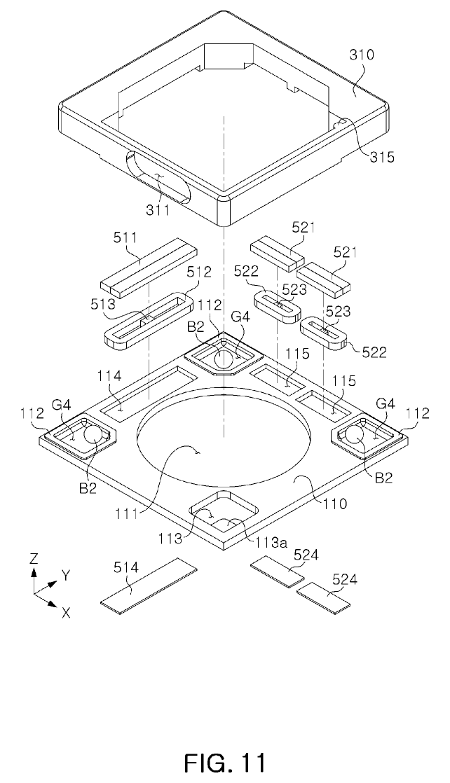

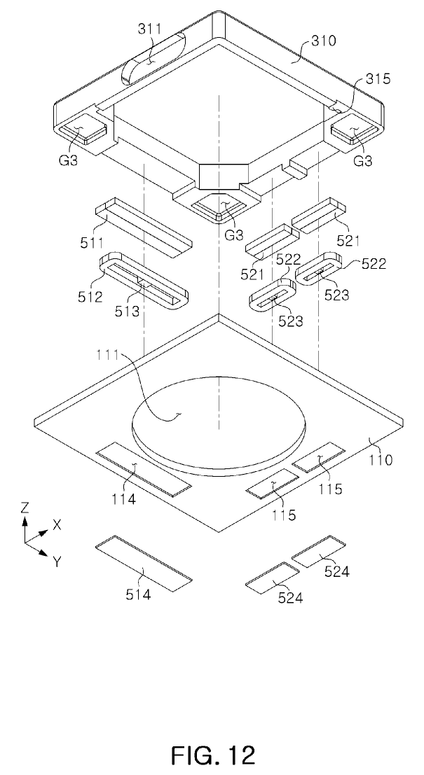

FIG. 11 is an exploded perspective view of an image stabilization unit, in accordance with one or more embodiments, and FIG. 12 is an exploded bottom perspective view of the image stabilization unit, in accordance with one or more embodiments.

According to an example embodiment, the carrier 310 may be supported by the base 110 across the second ball member B2.

As described above, in an example, the second ball member B2 may include three ball members, and the three ball members may be disposed in remaining three corner regions in which the first ball member B1 is not disposed, respectively.

The carrier 310 may include a third guide groove portion G3 on a surface facing the base 110 in the optical axis direction (Z-axis direction). A portion of the second ball member B2 may be accommodated in the third guide groove portion G3.

Similarly, the base 110 may include a fourth guide groove portion G4 on the surface facing the carrier 310 in the optical axis direction (Z-axis direction). When viewed in the optical axis direction (Z-axis direction), the base 110 may have a quadrangular shape having four corner regions, and the receiving groove 113 in which the extension portion 233 of the lens holder 230 is disposed may be formed in one of the four corner regions, and the fourth guide groove portion G4 may be formed in the remaining three corner regions.

The fourth guide groove portion G4 may face the third guide groove portion G3 in the optical axis direction (Z-axis direction), and some of the remaining portions of the second ball member B2 may be accommodated in the fourth guide groove portion G4.

A width of the third guide groove portion G3 and a width of the fourth guide groove portion G4 may be greater than a diameter of the second ball member B2. Accordingly, the second ball member B2 may roll in the directions perpendicular to the optical axis (Z-axis) based on a driving force that is generated by the image stabilization driving unit described below (hereinafter, a second driving unit 510 and a third driving unit 520) in a state of being accommodated in the third guide groove portion G3 and the fourth guide groove portion G4.

The third guide groove portion G3 and the fourth guide groove portion G4 may include a bottom surface and a plurality of side surfaces extending from the bottom surface in the optical axis direction (Z-axis direction), respectively. The second ball member B2 may be in contact with the bottom surfaces of the third guide groove portion G3 and the fourth guide groove portion G4. That is, the second ball member B2 may be in one-point contact with each of the third guide groove portion G3 and the fourth guide groove portion G4 (two-point contact in total).

The plurality of side surfaces of the third guide groove portion G3 and the fourth guide groove portion G4 may limit a movement distance of the second ball member B2 and may each serve as a stopper preventing separation. Accordingly, a distance between the plurality of side surfaces in the optical axis direction (Z-axis direction) may be less than the diameter of the second ball member B2.

As necessary, as illustrated in FIG. 11, a step portion 112 that protrudes in the optical axis direction (Z-axis direction) along an edge of the fourth guide groove portion G4 may be formed. Although the drawing illustrates an example in which the step portion 112 is formed on the edge of the fourth guide groove portion G4, this is only an example, and the step portion may also be formed along an edge of the third guide groove portion G3, or may be formed on both the edge of the third guide groove portion G3 and the edge of the fourth guide groove portion G4.

The carrier 310 may be spaced apart from the base 110 in the optical axis direction (Z-axis direction) by the second ball member B2, and may move relative to the base 110 in the directions perpendicular to the optical axis (Z-axis) based on a driving force that is generated by the second driving unit 510 and the third driving unit 520. In an example embodiment, the carrier 310 may move relative to the base 110 in the first axis direction (X-axis direction) and the second axis direction (Y-axis direction).

The second driving unit 510 may include a second driving magnet (or a third magnet) 511 and a second driving coil (or a second coil) 512 disposed to face each other, and the third driving unit 520 may include a third driving magnet (or a fourth magnet) 521 and a third driving coil (or a third coil) 522 disposed to face each other.

The second driving magnet 511 and the third driving magnet 521 may be disposed on one surface of the carrier 310 facing the base 110 in the optical axis direction (Z-axis direction), and the second driving coil 512 and the third driving coil 522 may be disposed on one surface of the base 110 facing the carrier 310 in the optical axis direction (Z-axis direction). Conversely, the second driving coil 512 and the third driving coil 522 may be disposed in the carrier 310 and the second driving magnet 511 and the third driving magnet 521 may be disposed in the base 110.

The second driving coil 512 and the third driving coil 522 may be mounted on a substrate (not shown) and may be disposed on one surface of the base 110. One surface of the base 110 may include a plurality of through-holes 114 and 115, and the second driving coil 512 and the third driving coil 522 may directly face the second driving magnet 511 and the third driving magnet 521 through the plurality of through-holes 114 and 115.

The second driving unit 510 and the third driving unit 520 may be disposed perpendicularly to each other. For example, the second driving magnet 511 and the third driving magnet 521 may be disposed perpendicularly to each other on one surface of the carrier 310, and the second driving coil 512 and the third driving coil 522 may be disposed perpendicularly to each other on one surface of the base 110.

Additionally, according to an example embodiment, the second driving unit 510 and the third driving unit 520 may include different numbers of magnets and coils. For example, the second driving unit 510 may include one second driving magnet 511 and one second driving coil 512, and the third driving unit 520 may include two third driving magnets 521 and two third driving coils 522. Each magnet and coil may correspond one-to-one to each other. Conversely, the second driving unit 510 may include two second driving magnets 511 and two second driving coils 512 and the third driving unit 520 may include one third driving magnet 521 and one third driving coil 522.

In an example, the N pole (or the S pole), the neutral region, and the S pole (or the N pole) may be disposed on one surface of the second driving magnet 511 facing the second driving coil 512 along the first axis direction (X-axis direction).

When power is applied to the second driving coil 512, the carrier 310 may be moved in the first axis direction (X-axis direction) based on an electromagnetic force that is generated between the second driving magnet 511 and the second driving coil 512.

The N pole (or the S pole), the neutral region, and the S pole (or the N pole) may be disposed on one surface of the third driving magnet 521 facing the third driving coil 522 along the second axis direction (Y-axis direction).

When power is applied to the third driving coil 522, the carrier 310 may be moved in the second axis direction (Y-axis direction) based on an electromagnetic force between the third driving magnet 521 and the third driving coil 522. Furthermore, power may be independently applied to two coils included in the third driving coil 522, thereby controlling rotation of the carrier 310.

The camera module 10 may include a plurality of position sensors 513 and 523 that sense a position of the carrier 310 in the direction perpendicular to the optical axis (Z-axis).

The plurality of position sensors 513 and 523 may be Hall sensors, and may each be provided in a state of being mounted on the substrate together with the second driving coil 512 and the third driving coil 522.

The plurality of position sensors 513 and 523 may directly face the second driving magnet 511 and the third driving magnet 521 through the plurality of through-holes 114 and 115. The plurality of position sensors 513 and 523 may sense a change in magnetic flux that is generated by the second driving magnet 511 and the third driving magnet 521 to sense the position of the carrier 310.

The plurality of position sensors 513 and 523 may include the second position sensor 513 facing the second driving magnet 511 and the third position sensor 523 facing the third driving magnet 521.

The third position sensor 523 may include two position sensors that face the third driving magnet 521, respectively. The two position sensors included in the third position sensor 523 may sense a rotation of the carrier 310.

A plurality of pulling yokes 514 and 524 may be disposed in the base 110 to face the second driving magnet 511 and the third driving magnet 521. The plurality of pulling yokes 514 and 524 may be attached to an outer side of the substrate (not shown) on which the above-described driving coils 512 and 522 and the position sensors 513 and 523 are mounted.

The plurality of pulling yokes 514 and 524 may include the first pulling yoke 514 facing the second driving magnet 511 and the second pulling yoke 524 facing the third driving magnet 521. The second pulling yoke 524 may be provided in two units and may correspond one-to-one to the third driving magnet 521.

The first pulling yoke 514 and the second pulling yoke 524 may each be formed of a material including a magnetic material. Accordingly, attractive forces may act between the second driving magnet 511 and the first pulling yoke 514 in a direction in which the second driving magnet 511 and the first pulling yoke 514 face each other ,and between the third driving magnet 521 and the second pulling yoke 524 in a direction in which the third driving magnet 521 and the second pulling yoke 524 face each other.

The second driving magnet 511 and the first pulling yoke 514 and the third driving magnet 521 and the second pulling yoke 524 may face each other in the optical axis direction (Z-axis direction), and may generate an attractive force in the optical axis direction (Z-axis direction). Due to the attractive force, the second ball member B2 may maintain contact with the carrier 310 and the base 110.

The second ball member B2 described above may be implemented by replacing the second ball member B2 with an injection molded product integrally formed with the carrier 310 or the base 110.

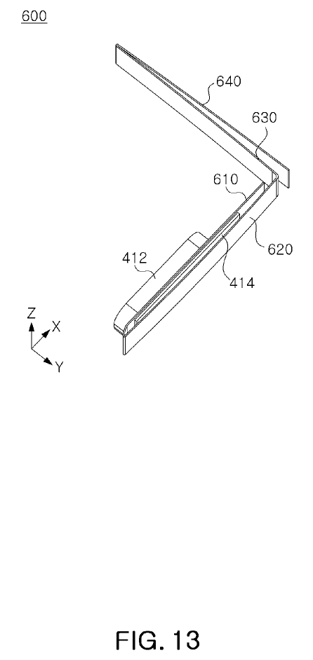

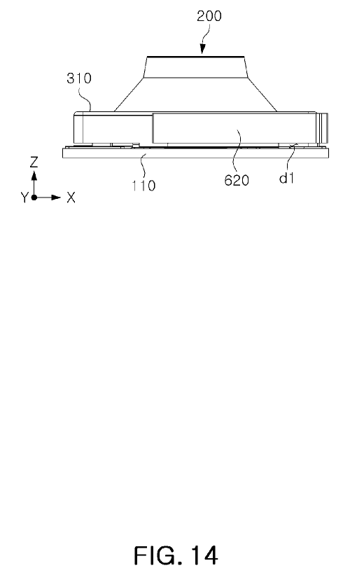

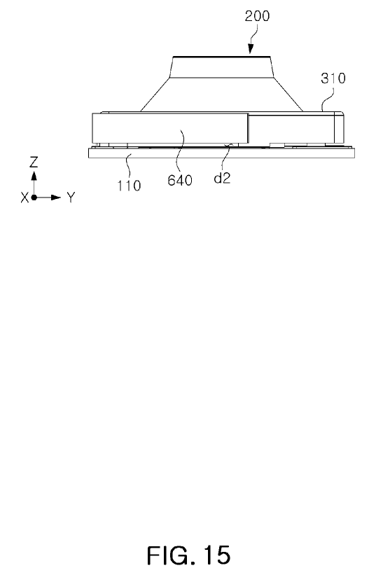

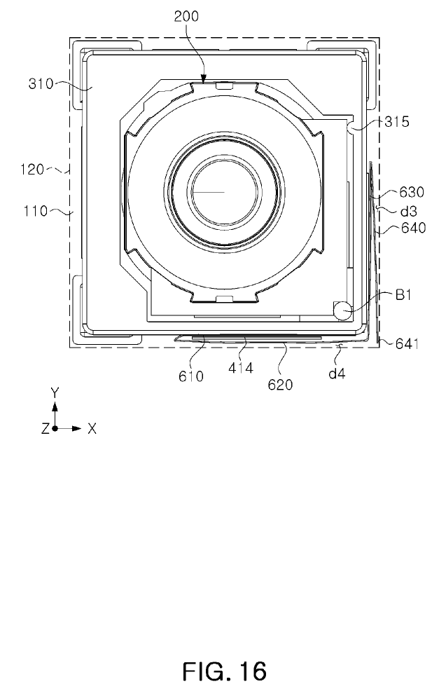

FIG. 13 is a perspective view of the connection substrate, in accordance with one or more embodiments, FIG. 14 is a first side view of the connection substrate (in a coupled state) , in accordance with one or more embodiments, FIG. 15 is a second side view of the connection substrate (in the coupled state) , in accordance with one or more embodiments, and FIG. 16 is a plan view of the connection substrate (in the coupled state) , in accordance with one or more embodiments.

According to an example embodiment, the first driving coil 412 facing the first driving magnet 411 may be disposed in the carrier 310, which is the movable body. Accordingly, the connection substrate 600 on which the first driving coil 412 is disposed may be configured to support a movement of the carrier 310.

At least a portion of the connection substrate 600 may be formed of a flexible material. The flexible material may be suitable for supporting a movement of the carrier 310.

The connection substrate 600 may have a shape that is bent multiple times, and may be disposed in a space between the carrier 310 and the shield can 120.

The connection substrate 600 may include four portions that are disposed at different positions between the carrier 310 and the shield can 120, and may be bent and extend at boundaries between the four portions.

The four portions may include a first portion 610, a second portion 620, a third portion 630, and a fourth portion 640. When the connection substrate 600 is unfolded, the first portion 610, the second portion 620, the third portion 630, and the fourth portion 640 may be sequentially arranged along a length direction of the connection substrate 600.

The first portion 610 may be disposed on one side surface of the carrier 310 facing the first side surface 231 of the lens holder 230.

The first driving coil 412 and the first position sensor 413 may be disposed on one surface of the first portion 610. The first portion 610 may be disposed to allow the one surface to face the lens holder 230, and the first driving coil 412 and the first position sensor 413 may face the first driving magnet 411 through the through-hole 311. The first yoke 414 may be disposed on a surface opposite to the one surface, and the first yoke 414 may face the first driving magnet 411 across the first driving coil 412 and the first position sensor 413. Various components may be disposed on the first portion 610, and the first portion 610 may thus be formed of a rigid material to secure rigidity.

The second portion 620 may be a portion that is bent and extended from the first portion 610 to be disposed substantially parallel to the first portion 610.

The second portion 620 may be disposed to be spaced apart from one side surface of the carrier 310 in the second axis direction (Y-axis direction) across the first portion 610. Additionally, the second portion 620 may be spaced apart from the first portion 610 in the second axis direction (Y-axis direction), and may also be spaced apart from the first yoke 414 in the second axis direction (Y-axis direction). The second portion 620 may be disposed on a surface opposite to the first portion 610 to be spaced apart from the shield can 120 in the second axis direction (Y-axis direction).

The third portion 630 may be a portion that is bent and extended from the second portion 620 to be disposed substantially perpendicular to the first portion 610 and the second portion 620.

The third portion 630 may be disposed to be spaced apart from one side surface of the carrier 310 facing the second side surface 232 of the lens holder 230 in the first axis direction (X-axis direction). Additionally, the third portion 630 may also be spaced apart from the second yoke 424 disposed on the one side surface of the carrier 310 in the first axis direction (X-axis direction).

The fourth portion 640 may be a portion that is bent and extended from the third portion 630 to be disposed substantially parallel to the third portion 630.

The fourth portion 640 may be disposed to be spaced apart from one side surface of the carrier 310 in the first axis direction (X-axis direction) across the third portion 630, and may also be spaced apart from the third portion 630 in the first axis direction (X-axis direction). At least a portion of the fourth portion 640 may be disposed on a surface opposite to the third portion 630 to be spaced apart from the shield can 120 in the first axis direction (X-axis direction).

Additionally, although not illustrated in the drawings, a connection portion (not shown) that receives an electrical signal from an external source may be formed in the fourth portion 640.

Referring to FIG. 16, one end 641 of the fourth portion 640 may be coupled to the shield can 120. That is, the connection substrate 600 may elastically support a movement of the carrier 310 in a state in which one end in the length direction is fixed to the fixed body 100.

As described above, as the first portion 610 of the connection substrate 600 is disposed in the carrier 310, the connection substrate 600 may move relative to the base 110 together with the carrier 310 in the directions (X-axis direction and Y-axis direction) perpendicular to the optical axis (Z-axis). In the connection substrate 600, one end 641 of the fourth portion 640 coupled to the shield can 120 may be a fixed portion, and the remaining portions may be movable portions.

Referring to FIGS. 14 and 15, the connection substrate 600 may be disposed to be spaced apart from the base 110 by distances d1 and d2 in the optical axis direction (Z-axis direction). Accordingly, when the connection substrate 600 moves together with the carrier 310, interference between the connection substrate 600 and the base 110 may be prevented.

The connection substrate 600 may be bent, and may extend between the carrier 310 and the shield can 120, and may be disposed to be spaced apart from the shield can 120 to support a movement of the carrier 310. Referring to FIG. 16, the fourth portion 640 of the connection substrate 600 may be disposed to be spaced apart from the shield can 120 by a distance d3 in the first axis direction (X-axis direction), and the second portion 620 may be disposed to be spaced apart from the shield can 120 by a distance d4 in the second axis direction (Y-axis direction).

The fourth portion 640 may be bent, and may extend from the second portion 620, and may be spaced apart from the shield can 120 in the first axis direction (X-axis direction), and the fourth portion 640 may thus operate to relax tension applied to the second portion 620 while moving in the first axis direction (X-axis direction) based on a driving force that is generated by the second driving unit 510. The third portion 630 that is bent and extended from the second portion 620, and that is disposed between the second portion 620 and the fourth portion 640, may also perform the same operation as the fourth portion 640. Similarly, the second portion 620 may relax tension applied to the third portion 630 and the fourth portion 640 while moving in the second axis direction (Y-axis direction) based on a driving force that is generated by the second driving unit 520.

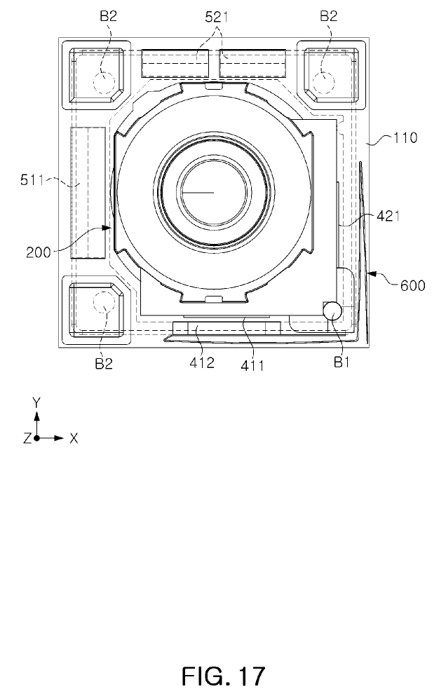

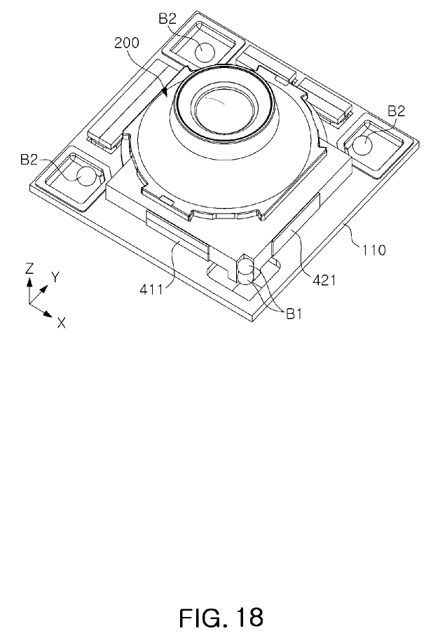

FIG. 17 is a plan view illustrating positions of the first support member and the second support member, in accordance with one or more embodiments, and FIG. 18 is a perspective view illustrating the positions of the first support member and the second support member, in accordance with one or more embodiments.

According to an example embodiment, the thickness H (FIG. 1) of the camera module 10 may be minimized by disposing the first ball member B1 that guides a movement of the lens module 200 in the optical axis direction (Z-axis direction), and the second ball member B2 that guides a movement of the carrier 310 in the directions (X-axis direction and Y-axis direction) perpendicular to the optical axis (Z-axis) so that they do not overlap each other in the optical axis direction (Z-axis direction).

Referring to FIG. 17, the first ball member B1 may be disposed in one corner region of the camera module 10, and the second ball member B2 may be disposed adjacent to the remaining corner regions excluding the one corner region of the camera module 10 in which the first ball member B1 is disposed.

Additionally, according to an example embodiment, the thickness (H) of the camera module 10 may be minimized by reducing the number of the first ball member B1 that guides a movement of the lens module 200 in the optical axis direction (Z-axis direction).

Referring to FIG. 18, in an example, the first ball member B1 may include two ball members that are disposed in the optical axis direction (Z-axis direction). That is, the camera module 10 according to an example embodiment may have at most two ball members that are stacked and disposed in the optical axis direction (Z-axis direction), and the camera module 10 may thus have a relatively slim thickness.

Furthermore, the second ball member B2 that guides a movement of the carrier 310 in the directions (X-axis direction and Y-axis direction) perpendicular to the optical axis (Z-axis), may be disposed in a single stage. That is, the second ball member B2 may be limited only in movement in the optical axis direction (Z-axis direction), and may freely move on a plane (X-Y plane) perpendicular to the optical axis (Z-axis). Accordingly, the camera module 10 may have a relatively slim thickness compared to a structure in which the second ball member B2 includes a ball member having a degree of freedom in the first axis direction (X-axis direction) and a ball member having a degree of freedom in the second axis direction (Y-axis direction), respectively.

Finally, although not illustrated in the drawings, the example camera module 10, in accordance with one or more embodiments, may include an image sensor that converts incident light into an electrical signal.

According to an example embodiment, the image sensor may be mounted on a sensor substrate, and may be disposed on a lower surface of the base 110. The image sensor may face the lens barrel 210 in which a plurality of lenses are mounted in the optical axis direction (Z-axis direction) through a second opening 111 of the base 110. Accordingly, light passing through the plurality of lenses may be incident on the image sensor.

An infrared cut filter (IR cut filter) that blocks light in an infrared region among incident light may be further disposed between the image sensor and the lens barrel 210.

In an example, as described above, in another example embodiment, the optical module 200 may be the image sensor module. According to another example embodiment, the image sensor may be disposed in the inner space that is formed by the base 110 and the shield can 120, and may be moved in the optical axis direction (Z-axis direction) and in the directions (X-axis direction and Y-axis direction) perpendicular to the optical axis (Z-axis).

As set forth above, according to the example embodiments, the camera module may have a slim thickness.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a base;
a first carrier supported by the base, and configured to move in a direction perpendicular to an optical axis direction;
a second carrier supported by the first carrier, and configured to move in the optical axis direction; and
an optical member disposed in the second carrier,
wherein a first support member that supports a movement of the second carrier in the optical axis direction is disposed between the first carrier and the second carrier,
wherein the first support member is disposed between a first corner portion that is disposed at an edge at which two adjacent side surfaces of the second carrier meet and a second corner portion that is disposed at an edge at which two adjacent side surfaces of the first carrier meet, and
wherein the second corner portion faces the first corner portion in the direction perpendicular to the optical axis direction.

2. The camera module according to claim 1, wherein the first support member is a first ball member, and
wherein the first ball member comprises two balls that are disposed in the optical axis direction.

3. The camera module according to claim 1, wherein a first guide groove portion that is defined by the two adjacent side surfaces of the second carrier is disposed at the first corner portion,
wherein a second guide groove portion that is defined by the two adjacent side surfaces of the first carrier, and facing the first guide groove portion is disposed at the second corner portion, and
wherein the first support member is disposed between the first guide groove portion and the second guide groove portion.

4. The camera module according to claim 1, wherein a first magnet and a second magnet are disposed in the second carrier at positions that are spaced apart from the first support member in the direction perpendicular to the optical axis direction, and
wherein a first coil that faces one of the first magnet and the second magnet, a first yoke that faces the first magnet, and a second yoke that faces the second magnet, are disposed in the first carrier.

5. The camera module according to claim 4, wherein the second carrier comprises a first side surface and a second side surface that are perpendicular to each other,
wherein the first magnet is disposed on the first side surface, and
wherein the second magnet is disposed on the second side surface.

6. The camera module according to claim 5, wherein the first yoke faces the first magnet in a first axis direction perpendicular to the optical axis direction, and
wherein the second yoke faces the second magnet in a second axis direction perpendicular to both the optical axis direction and the first axis direction.

7. The camera module according to claim 6, wherein the first yoke and the second yoke each comprise of a magnetic material, and
wherein the first magnet and the first yoke and the second magnet and the second yoke are configured to generate magnetic attractive forces in directions in which the first magnet and the first yoke face each other, and in which the second magnet and the second yoke face each other.

8. The camera module according to claim 6, wherein the first magnet is spaced apart from the first support member by a first distance D1 in the second axis direction, and
wherein the second magnet is spaced apart from the first support member by a second distance D2 that is different from the first distance D1 in the first axis direction.

9. The camera module according to claim 8, wherein the first coil is configured to face the first magnet, and
wherein the first distance D1 is less than the second distance D2.

10. The camera module according to claim 9, wherein the first carrier or the second carrier comprises an auxiliary support portion that is disposed to be spaced apart from the first support member in the first axis direction.

11. The camera module according to claim 1, wherein a second support member that supports a movement of the first carrier in the direction perpendicular to the optical axis direction is disposed between the base and the first carrier, and
wherein the first carrier is configured to move in a first axis direction perpendicular to the optical axis direction and in a second axis direction perpendicular to both the optical axis direction and the first axis direction.

12. The camera module according to claim 11, wherein the second support member is a second ball member,
wherein the second ball member comprises three balls, and
wherein the second ball member is disposed at a position that is spaced apart from the first support member in the direction perpendicular to the optical axis direction.

13. The camera module according to claim 12, wherein, when viewed in the optical axis direction, the base has a quadrangular shape having four corner regions, and
wherein one of the first support member and the second support member is disposed in each of the four corner regions.

14. The camera module according to claim 11, wherein a third magnet and a fourth magnet are disposed perpendicularly to each other in the first carrier or the base, and
wherein a second coil and a third coil are disposed in the base or the first carrier to face the third magnet and the fourth magnet in the optical axis direction.

15. The camera module according to claim 14, wherein the fourth magnet comprises a plurality of magnets,
wherein the second coil comprises a number of coils that correspond to a number of the third magnets, and
wherein the third coil comprises a number of coils that correspond to a number of the fourth magnets.

16. The camera module according to claim 15, further comprising a plurality of position sensors that are disposed to face the third magnet and the fourth magnet, respectively,
wherein a number of the position sensors that face the fourth magnets corresponds to a number of the fourth magnets.

17. The camera module according to claim 4, further comprising a shield can that is coupled to the base, and
a connection substrate that is disposed between the first carrier and the shield can.

18. The camera module according to claim 17, wherein the connection substrate comprises:
a movable portion in which the first coil and the first yoke are disposed, and which is configured to move together with the first carrier, and
a fixed portion that is coupled to the shield can.

19. The camera module according to claim 1, wherein the optical member comprises a plurality of lenses that are disposed in the optical axis direction.

20. A camera module, comprising:
a lens module configured to move in an optical axis direction;
a carrier in which the lens module is disposed, and which is supported by a base;
a first magnet and a second magnet which are disposed perpendicularly to each other in the lens module;
a first coil disposed in the carrier;
a first yoke and a second yoke disposed perpendicularly to each other; and
a first support member disposed between the lens module and the carrier and configured to support a movement of the lens module in the optical axis direction,
wherein the first magnet faces the first coil and the first yoke,
wherein the second magnet faces the second yoke, and
wherein the first support member is disposed between the first yoke and the second yoke.

21. The camera module according to claim 20, wherein the first magnet and the first yoke face each other in a first direction perpendicular to the optical axis direction,
wherein the second magnet and the second yoke face each other in a second direction perpendicular to both the optical axis direction and the first direction, and
wherein the first yoke and the second yoke each comprise a magnetic material, and are each configured to generate magnetic attractive forces toward the first magnet and the second magnet.

22. The camera module according to claim 21, wherein the first magnet is spaced apart from the first support member by a first distance D1 in the second direction,
wherein the second magnet is spaced apart from the first support member by a second distance D2 in the first direction, and
wherein the first distance D1 is less than the second distance D2.

23. The camera module according to claim 20, wherein the lens module comprises a lens barrel in which a plurality of lenses are disposed in the optical axis direction and a lens holder coupled to the lens barrel, and
wherein the first support member is disposed to be in contact with the lens holder and the carrier.

24. The camera module according to claim 23, wherein the lens holder comprises an extension portion that protrudes toward the base in the optical axis direction at a position where the first support member is disposed, and
wherein the base comprises a receiving groove that faces the extension portion in the optical axis direction and the extension portion is disposed in the receiving groove.

25. The camera module according to claim 24, wherein the first support member is a first ball member comprising a plurality of balls, and
wherein the receiving groove comprises a step portion that protrudes toward the first ball member in the optical axis direction.

26. The camera module according to claim 20, further comprising a shield can coupled to the base,
wherein the first support member is a first ball member comprising a plurality of balls, and
wherein the shield can comprises a protrusion portion that protrudes toward the first ball member in the optical axis direction.

27. The camera module according to claim 20, wherein a substrate is disposed in the carrier, and
wherein the first coil is disposed on one surface of the substrate facing the lens module.

28. The camera module according to claim 27, wherein the first yoke is disposed in the carrier through the substrate, and
wherein the second yoke is directly disposed in the carrier.

29. The camera module according to claim 20, further comprising:
a third magnet and a fourth magnet disposed in the carrier or the base;
a second coil and a third coil disposed in the base or the carrier to face the third magnet and the fourth magnet in the optical axis direction; and
a second ball member disposed between the carrier and the base,
wherein the carrier is configured to move relative to the base in a direction perpendicular to the optical axis direction.

30. The camera module according to claim 29, wherein the third magnet and the fourth magnet are disposed perpendicularly to each other, and
wherein one of the third magnet and the fourth magnet comprises one magnet, and another of the third magnet and the fourth magnet comprises two magnets.
